(19) United States
(12) Patent Application Publication
(10) Pub. No.: US 2003/0145290 A1
(43) Pub. Date: Jul. 31, 2003

(54) System for controlling external models used for verification of system on a chip (SOC) interfaces

(75) Inventors: Robert J. Devins, Essex Junction, VT (US); Paul G. Ferro, South Burlington, VT (US); Emory D. Keller, Jericho, VT (US); David W. Milton, Underhill, VT (US)

Correspondence Address: FREDERICK W. GIBB, III, MCGINN & GIBB, PLLC, 2568-A RIVA ROAD, SUITE 304, ANNAPOLIS, MD, 21401, US

(73) Assignee: INTERNATIONAL BUSINESS MACHINES CORPORATION, ARMONK, NY

(21) Appl. No.: 10/060,750

(22) Filed: Jan. 30, 2002

(51) Int. Cl. G06F 17/50

(52) U.S. Cl. 716/4

(57) ABSTRACT

A method and structure for a verification test bench system for testing an interface of a system-on-a-chip (SOC) that includes a verification interface model connected to the SOC interface and a test bench external bus interface unit (EBIU) connected to the verification interface model. The test bench EBIU is connected to a SOC EBIU within the SOC. The test bench EBIU and the SOC EBIU are mastered by the same processor in the SOC, such that the SOC interface and the verification interface model are programmed by the same test case running in the SOC.

### BACKGROUND OF THE INVENTION

1. Field of the Invention

The present invention relates generally to the verification of integrated circuit (IC) logic, and more particularly to a method and system for increasing the efficiency and reusability of verification software and the verification environment.

2. Description of the Related Art

Before ICs are released to market, the logic designs incorporated therein are typically subject to a testing and de-bugging process known as “verification.” Verification of logic designs using simulation software allows a significant number of design flaws to be detected and corrected before incurring the time and expense needed to physically fabricate designs.

Hardware verification typically entails the use of software “models” of design logic. Such models may be implemented as a set of instructions in a hardware description language (HDL). The models execute in a simulation environment and can be programmed to simulate a corresponding hardware implementation. The simulation environment comprises specialized software for interpreting model code and simulating the corresponding hardware device or devices. By applying test stimuli (typically in batches known as “test cases”) to a model in simulation, observing the responses of the model and comparing them to expected results, design flaws can be detected and corrected.

Advances in technology have permitted logic designs to be packed with increased density into smaller areas of silicon as compared with past IC devices. This has led to “system-on-a-chip” (SOC) designs. The term “SOC” as used herein refers to combinations of discrete logic blocks, often referred to as “cores,” each performing a different function or group of functions. A SOC integrates a plurality of cores into a single silicon device, thereby providing a wide range of functions in a highly compact form. Typically, an SOC is comprised of a processor core (often referred to as an “embedded” processor), and will further comprise one or more cores for performing a range of functions often analogous to those of devices in larger-scale systems.

In its developmental stages, a core is typically embodied as a simulatable HDL model written at some level of abstraction, or in a mixture of abstraction levels. Levels of abstraction that are generally recognized include a behavioral level, a structural level, and a logic gate level. A core may be in the form of a netlist including structural and logic gate elements or a behavioral model.

Verification of a SOC presents challenges because of the number of cores and the complexity of interactions involved, both between the cores internally to the SOC, and between the SOC and external logic. An acceptable level of verification demands that a great number of test cases be applied, both to individual components of the SOC, and to the cores interconnected as a system and interfacing with logic external to the SOC. There is a commensurate demand on computer resources and time. Accordingly, techniques which increase the efficiency of verification are at a premium.

According to one standard technique, already-verified models are used to test other models. The electronic design automation (EDA) industry has reached a level of sophistication wherein vendors offer standardized models for use in verification of other models still in development. In particular, such models are typically used for testing cores in a SOC that have external interfaces (i.e., communicate with logic external to the SOC). Such standardized models save the purchaser development resources, are typically well-tested and reliable, and are designed to have a wide range of applicability.

However, there are disadvantages associated with using standardized models. For instance, they can be very costly. Moreover, they can be very complex and provide much more functionality than is needed by the purchaser if only a subset of functions are required. Further, the standardized models must be integrated into existing verification systems, incurring more cost in terms of time and effort.

Alternatively to purchasing and using standardized models, designers may, of course, develop their own testing models. However, this is costly in terms of development time, with the typical result that such models are designed for limited application. Accordingly, they typically have limited functionality and reusability.

### SUMMARY OF THE INVENTION

In view of the foregoing and other problems, disadvantages, and drawbacks of the conventional verification test benches, the present invention has been devised, and it is an object of the present invention to provide a structure that attaches an external model to a SOC interface and to an external bus interface unit.

In order to attain the object suggested above, there is provided, according to one aspect of the invention, a verification test bench system. This system tests an interface of a system-on-a-chip (SOC). The verification test bench system comprises a verification interface model which is connected to the SOC interface and a test bench external bus interface unit (EBIU) connected to the interface model. The test bench EBIU is connected to the SOC EBIU. The SOC interface and verification interface models are programmable by a test case that runs in the SOC. The test bench EBIU allows a test case to control both the SOC interface and the interface model. The test case can use either the same or different software drivers to configure and control the SOC interface and verification interface models.

The invention represents a clean way of controlling external interface models without the need for a complex control mechanism such as the conventional semaphore derived scheme used to enable communication between the SOC being tested and the external interface model. The external bus mastering of the test bench EBIU 200 allows external model programming from the SOC test case. Thus, the same test case directly controls operations of the SOC interface 101 and the external model 210.

### BRIEF DESCRIPTION OF THE DRAWINGS

The foregoing and other objects, aspects and advantages will be better understood from the following detailed description of the preferred embodiments of the invention with reference to the drawings, in which:

FIG. 1 is a schematic diagram illustrating connections between an SOC and an external verification model comprising an interface model and an external bus interface unit; and

FIG. 2 is a schematic diagram of a computer system which can be used to implement the present invention.

### DETAILED DESCRIPTION OF PREFERRED EMBODIMENTS OF THE INVENTION

The invention provides a structure that controls an external model(s) used for interconnection verification of an SOC interface. An important feature of the invention is to connect the external model to an external bus interface unit (EBIU) via a local bus. The EBIU is then connected to the SOC's EBIU. This connection enables the external model to be completely controlled from the test case running in the SOC by using the EBIU's external bus mastering capability. The EBIU in this invention is not a specific core or unit and is meant to refer to any communications channel that can connect the SOC to the external model and provide the external bus mastering functionality. This allows the test case to program the external model to perform such tasks as data transfers and other interface specific functions necessary to thoroughly verify the SOC interface. The same test case is also used to program the SOC interface.

Present methods for controlling external models generally involve decoupled control between the test case and the external model(s). They are essentially different entities within the test bench written in separate control languages (HDL or Bus Functional Models) that require their own separate programming languages, and thus require different software to control each.

Additionally, test coordination between the test case and the external model involve complex communication schemes such as semaphore types where the test case running on the SOC will set a flag or write a value to a test bench memory model or register array that the external model can read as a signal to perform some operation. Alternatively, the external model simply runs through its own “pre-canned” operations such as sending test data to the SOC interface when it is turned on by the start of a test in the test bench.

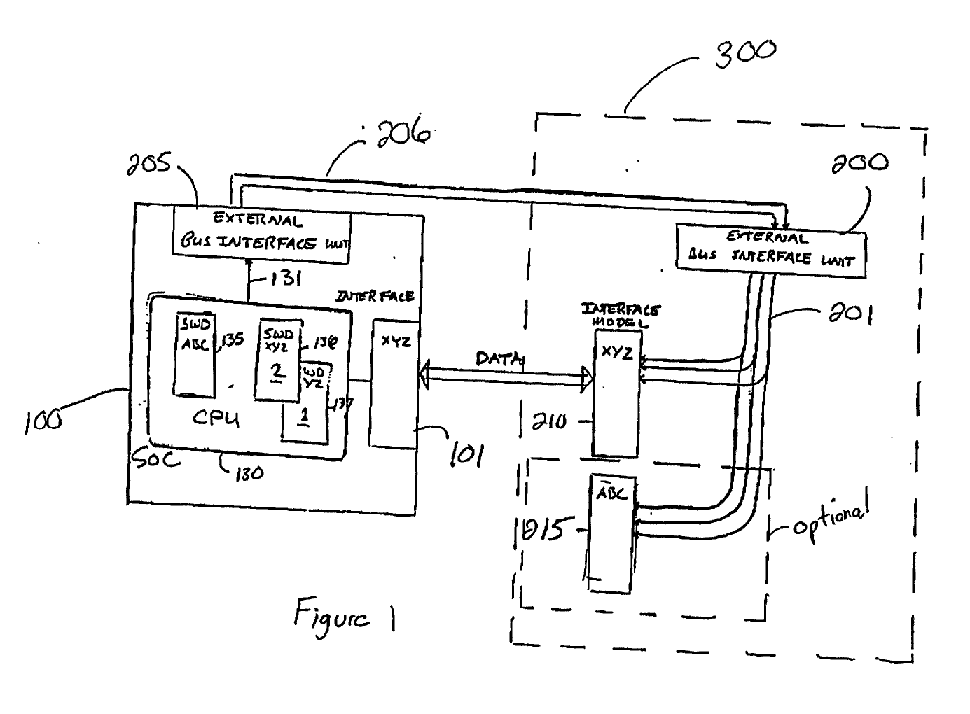

To the contrary, the present invention implements control by attaching an EBIU 200 to an external interface model 210 (e.g., a verification interface model) via a local bus structure 201, as shown in FIG. 1. This essentially creates enough of an external SOC structure 300 (e.g., a verification test bench) that is capable of having data or commands transferred from an external source (the SOC 100 in this case) through the test bench EBIU 200 into or through the verification interface model 210.

The test bench EBIU 200 attaches to the SOC EBIU 205 via an external bus 206. The internal bus structure 201 within the verification test bench 300 is implemented to respond to an address range that is unique to the SOC, giving complete control to a single verification test running in the SOC 100. In addition, FIG. 1 illustrates various internal components of the SOC 100 including the central processing unit (CPU) 130 and the test patterns 135-137.

Item 215 represents an extra external interface model that the invention can be optionally used to test more than one type of SOC interface. Items 135-137 represent different software drivers (SWD) for driving or configuring different interfaces of the SOC. A software driver is software written only for a specific hardware device like a printer or a specific interface of an SOC. The test cases are written to utilize software drivers to configure the core or units they are testing.

In operation, the structure in FIG. 1 utilizes the interface model 210 to test the SOC's interface 101. A bus master can configure other units or cores connected to a bus, whereas a bus slave can only respond to a master's commands. The EBIU 200 (slave) responds to external bus master commands from the CPU 130, thereby enabling a test case running in the SOC 100 to direct the CPU 130 (which is a master on the SOC's internal bus 131) to act as a master on the test bench's internal bus 201. Thus, the test case running in the SOC 100 can direct the SOC CPU 130 to program (e.g., master) the registers in both the internal interface 101 and the interface model 210. Here the same test case software is used to program both the SOC's interface 101 and the external entity's 300 interface model 210.

In FIG. 1, the invention transfers data from the external interface model 210 to the SOC interface 101. The test case calls the software driver (SWD) 135-137 for the interface 101 and instructs the software driver to configure the interface 101 to receive data. Next, the test case calls the same SWD 135-137 and instructs the software driver to configure the external interface model 210 to send data. The SOC's interface 101 and the external interface model 210 are implemented to respond to different unique addresses. Thus, when the test case calls the SWD 135-137 to perform some configuration on one of the interfaces, the test case sends the address of that interface along with the operation to be performed. The test case then sends test data to the unique data address of the external interface model 210. This data is sent from the SOC 100 through the SOC's external bus interface unit (EBIU) 205 to the external EBIU 200 and then along to the interface model 210. From there the data is sent through the interface model 210 into the SOC's interface 101 which is configured to receive data. Once the data is back in the SOC 100, the test case checks it for correctness and a test status is recorded.

One advantage achieved with the invention is better software control. The invention allows the test case executing in the SOC 100 to use the same software driver, if appropriate, to program both interfaces 101, 210. The test case can also use one driver to program the SOC interface 101 and another to program the interface model 210, both of which are controlled by the test case. This is an improvement over the conventional situation where the test case running within the SOC 100 controls the SOC interface 101, and another software program (written in a bus functional language) controls the external interface 210. The invention provides increased reusability and decreased development time because the invention uses the same or similar software written in the same language to program both interfaces.

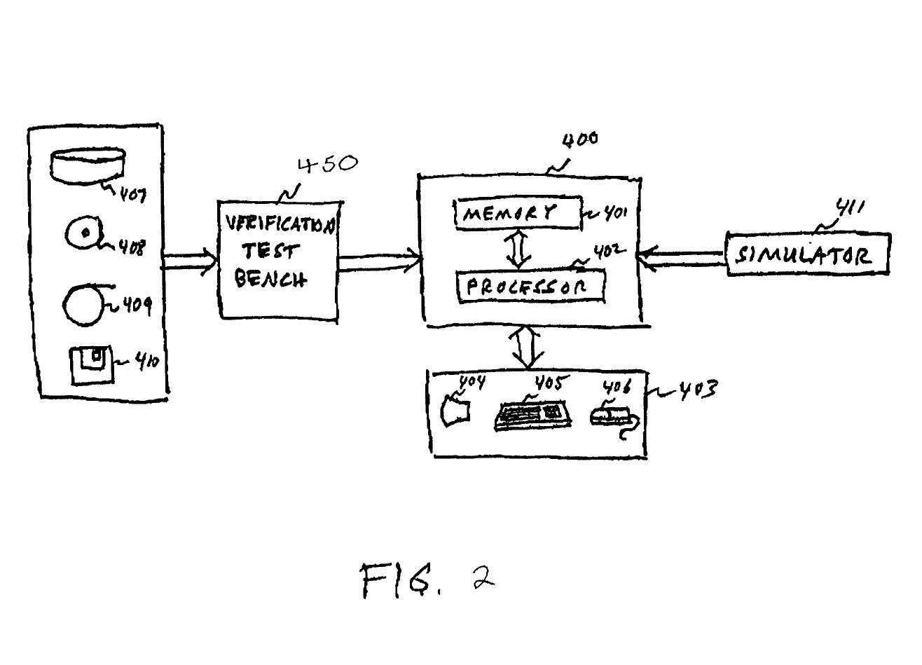

FIG. 2 shows a computer system which can be used to implement the present invention. The system includes a computer 400 comprising a memory 401 and processor 402 which may be embodied, for example, in a workstation. The system may include a user interface 403 comprising a display device 404 and user input devices such as a keyboard 405 and mouse 406. The verification test bench 450 may be implemented as computer-executable instructions which may be stored on computer-usable media such as disk storage 407, CD-ROM 408, magnetic tape 409 or diskette 410. The instructions may be read from a computer-usable medium as noted into the memory 401 and executed by the processor 402 to effect the advantageous features of the invention. A simulator 411 loaded into computer memory 401 and executed by processor 402 interprets a compiled verification test bench to simulate hardware devices corresponding thereto. The simulator 411 may be any of a variety of commercially available simulators, including event simulators, cycle simulators and instruction set simulators. Programming structures and functionality implemented in computer-executable instructions as disclosed herein-above for performing steps of the method may find specific implementations in a variety of forms, which are considered to be within the abilities of a programmer of ordinary skill in the art.

The invention represents a clean way of controlling external interfaces without the need for a complex control mechanism such as the conventional semaphore derived scheme used to enable communication between the SOC being tested and the external interface. The external bus mastering of the test bench EBIU 200 allows external model programming from the SOC test case. Thus, the same test case directly controls operations of the SOC interface 101 and the external model 210. Sometimes the external model needed to verify the SOC interface 101 comprises a different type of interface such that it cannot be programmed with the same driver. The invention readily accommodates such interfaces by also having the ability to individually program the non-conforming external interface using a separate, appropriate driver. Thus, the invention achieves an advantage by effectively controlling external models 210 that are necessary to verify the interconnection of SOC external interfaces 101 in an efficient and simple manner.

While the invention has been described in terms of preferred embodiments, those skilled in the art will recognize that the invention can be practiced with modification within the spirit and scope of the appended claims.

What is claimed is:

1. A verification test bench system for testing a system-on-a-chip (SOC) interface of an SOC, said verification test bench system comprising:
a verification interface model connected to said SOC interface; and
a test bench external bus interface unit (EBIU) connected to said verification interface model,
wherein said test bench EBIU is connected to a SOC EBIU within said SOC.

2. The verification test bench system in claim 1, wherein said SOC EBIU allows a test case running in said SOC to control both said SOC interface and said verification interface model.

3. The verification test bench system in claim 1, wherein said SOC interface and said verification interface model are programmed by a test case running in said SOC.

4. The verification test bench in claim 3, wherein said test case utilizes the same software driver to configure and control said SOC interface and said verification interface model.

5. The verification test bench in claim 3, wherein said test case utilizes different software drivers to configure and control said SOC interface and said verification interface model.

6. The verification test bench system in claim 1, wherein said verification interface model tests an operational capability of said SOC interface.

7. The verification test bench system in claim 1, further comprising at least one additional verification interface model connected to said test bench EBIU for testing additional types of SOC interfaces.

8. A verification test bench system for testing a system-on-a-chip (SOC) interface of an SOC, said verification test bench system comprising:
a verification interface model connected to said SOC interface; and
a test bench external bus interface unit (EBIU) connected to said verification interface model,
wherein said test bench EBIU is connected to a SOC EBIU within said SOC, and
wherein said test bench EBIU and said SOC EBIU are mastered by the same processor in said SOC.

9. The verification test bench system in claim 8, wherein said SOC EBIU allows a test case running in said SOC to control both said SOC interface and said verification interface model.

10. The verification test bench system in claim 8, wherein said SOC interface and said verification interface model are programmed by the same test case running in said SOC.

11. The verification test bench in claim 10, wherein said test case utilizes the same software driver to configure and control said SOC interface and said verification interface model.

12. The verification test bench in claim 10, wherein said test case utilizes different software drivers to configure and control said SOC interface and said verification interface model.

13. The verification test bench system in claim 8, wherein said verification interface model tests an operational capability of said SOC interface.

14. The verification test bench system in claim 8, further comprising at least one additional verification interface model connected to said test bench EBIU for testing additional types of SOC interfaces.

15. A verification test bench system for testing a system-on-a-chip (SOC) interface of an SOC, said verification test bench system comprising:
a verification interface model connected to said SOC interface; and
a test bench external bus interface unit (EBIU) connected to said verification interface model,
wherein said test bench EBIU is connected to a SOC EBIU within said SOC, and
wherein said test bench EBIU and said SOC EBIU are mastered by the same processor in said SOC, such that said SOC interface and said verification interface model are programmed by the same test case running in said SOC.

16. The verification test bench system in claim 15, wherein said SOC EBIU allows said test case to control both said SOC interface and said verification interface model.

17. The verification test bench in claim 15, wherein said test case utilizes the same software driver to configure and control said SOC interface and said verification interface model.

18. The verification test bench in claim 15, wherein said test case utilizes different software drivers to configure and control said SOC interface and said verification interface model.

19. The verification test bench system in claim 15, wherein said verification interface model tests an operational capability of said SOC interface.

20. The verification test bench system in claim 15, further comprising at least one additional verification interface model connected to said test bench EBIU for testing additional types of SOC interfaces.

21. A method of testing a system-on-a-chip (SOC) interface of an SOC, said method comprising:
connecting a verification interface model to said SOC interface;
connecting a test bench external bus interface unit (EBIU) to said verification interface model;
connecting said test bench EBIU to a SOC EBIU within said SOC; and
comparing said SOC interface with said interface model.

22. The method in claim 21, further comprising allowing, through said SOC EBIU, a test case running in said SOC to control both said SOC interface and said verification interface model.

23. The method in claim 21, further comprising programming said SOC interface and said verification interface model by a test case running in said SOC.

24. The method in claim 23, wherein said test case utilizes the same software driver to configure and control said SOC interface and said verification interface model.

25. The method in claim 23, wherein said test case utilizes different software drivers to configure and control said SOC interface and said verification interface model.

26. The method in claim 21, wherein said comparing process tests an operational capability of said SOC interface.

27. The method in claim 21, further comprising:
connecting at least one additional verification interface model to said test bench EBIU; and
testing additional types of SOC interfaces.

28. A program storage device readable by machine tangibly embodying a program of instructions executable by the machine to perform a method for testing a system-on-a-chip (SOC) interface of an SOC, said method comprising:
connecting a verification interface model to said SOC interface;
connecting a test bench external bus interface unit (EBIU) to said verification interface model;
connecting said test bench EBIU to a SOC EBIU within said SOC; and
comparing said SOC interface with said interface model.

29. The program storage device in claim 28, wherein said method further comprises allowing, through said SOC EBIU, a test case running in said SOC to control both said SOC interface and said verification interface model.

30. The program storage device in claim 28, wherein said method further comprises programming said SOC interface and said verification interface model by a test case running in said SOC.

31. The program storage device in claim 30, wherein said test case utilizes the same software driver to configure and control said SOC interface and said verification interface model.

32. The program storage device in claim 30, wherein said test case utilizes different software drivers to configure and control said SOC interface and said verification interface model.

33. The program storage device in claim 28, wherein said comparing process tests an operational capability of said SOC interface.

34. The program storage device in claim 28, wherein said method further comprises:
connecting at least one additional verification interface model to said test bench EBIU; and
testing additional types of SOC interfaces.
